(19) United States
(12) Patent Application Publication
(10) Pub. No.: US 2003/0020274 A1
(43) Pub. Date: Jan. 30, 2003

(54) Adhesive label having nonadhesive tab portion

(76) Inventor: J. Michael Milliorn, Fort Worth, TX (US)

Correspondence Address: FULBRIGHT & JAWORSKI, LLP, 1301 MCKINNEY, SUITE 5100, HOUSTON, TX, 77010-3095, US

(21) Appl. No.: 09/912,755

(22) Filed: Jul. 24, 2001

(51) Int. Cl. B42D 15/00

(52) U.S. Cl. 283/81

(57) ABSTRACT

The present invention provides a label having an adhesive surface operable to releasably adhere the label to a substrate surface under extreme conditions. The label further includes an adhesive free tab that provides an integral means for lifting the releasable label from the surface to which it is adhered. The tab section is specially configured so as to resist tearing of the label when being removed.

### FIELD OF THE INVENTION

The present invention relates to adhesive labels, and particularly, to adhesive labels having a durable sheet layer together with an adhesive layer for maintaining the label adhered to a surface under extreme conditions. More particularly, the adhesive label includes an adhesive layer having particular properties, which enable the label to be lifted from the surface using the provided tab portion.

### BACKGROUND OF THE INVENTION

Food safety is a major concern for restaurants and other establishments involved in the storage and preparation of food for human consumption. To ensure such food safety, those involved in food storage and preparation frequently use removable adhesive labels attached to the surface of a container holding food to inform the food handler as to the type of food and its date of preparation and/or date of possible spoilage.

There are three main types of labels used in these food safety labeling systems—day of the week FIFO (first in first out) systems, shelf-life/product identification labels and use by/use first labeling. Food safety labeling systems also use an industry standard color code system of blue for Monday, yellow for Tuesday, red for Wednesday, brown for Thursday, green for Friday, orange for Saturday, and black for Sunday on the labels. These colors are used to quickly identify the days of the week on labels used in food safety labeling systems.

It is desired that an adhesive label used in such a manner be able to function in both high and low temperature environments. Specifically, the adhesive label must remain adhered to the surface of the container under refrigerated conditions. Additionally, it is desirable to have a label resistant to high temperatures so that if the container is cleaned, before the label is removed, it will not deteriorate during cleaning and can be easily removed later.

It is customary practice to replace the adhesive label with a new label once the food is used and the container is cleaned. To remove the label, an individual normally removes the label by hand or by using a high temperature washing. There are adhesive labels that are known to dissolve when subjected to such high temperature conditions, such as in a high temperature dishwasher. If such a dissolvable label is not used, however, the adhesive layer holding a conventional label to the surface frequently leaves a residue or a label remnant on the surface.

Thus, there is a demonstrated need for an adhesive label that can withstand extreme temperature fluctuations without compromising the label's integrity, enabling it to be removed later. Additionally, there is a need for an adhesive label that will remain securely adhered to a surface, but is easily removed from that surface without requiring a wash.

### SUMMARY OF THE INVENTION

In accordance with the present invention, there is provided an adhesive label comprising a sheet material operable to withstand extreme conditions, such as extreme hot and cold, and is highly resistant to physical wear. Importantly, the adhesive label of the present invention will not dissolve, wear off, or leave a residue when subjected to washing conditions. Particularly, the adhesive label of the present invention includes a sheet material having first and second opposite sides, wherein the first side includes an adhesive layer adapted to releasably adhere to a substate and the second side is adapted to be written upon with a pencil or pen. The label further includes at least a portion of the first side being free of any adhesive layer. In this way, the adhesive free portion of the label provides the user with a tab portion that is used to physically lift the label from the receiving surface.

Therefore, in accordance with a general embodiment of the present invention, there is provided an adhesive label comprising a first section having first and second opposite sides. The first side of the first section comprises an adhesive adapted to releasably adhere the label to a receiving surface. A second section is joined to the first section, the second section being configured to extend away from the first section so as to form a tab portion. The tab portion having a first side that is contiguous with the first side of the first section. The first side of the tab portion is free of an adhesive layer.

In a further embodiment of the present invention, the tab portion, or second section, of the adhesive label of the present invention includes an edge that converges with an edge of the first section. In this embodiment, the two converging edges define an arcuate or rounded edge that is resistant to tearing when the tab portion is lifted away from the receiving surface to remove the label.

In a further embodiment of the present invention, the adhesive label is fabricated from a polypropylene sheet material that includes an adhesive layer comprising a rubber based hot melt adhesive.

Other embodiments, features and advantages of the present invention will become apparent from a review of the detailed description of the preferred embodiments, including the illustrative drawings and the appended claims which follow.

### BRIEF DESCRIPTION OF THE DRAWINGS

FIG. 1 is a front side view of a preferred embodiment of the present invention showing the converging label edges forming a rounded corner between the tab portion and the label portion;

FIG. 2 is a back side view of the preferred embodiment of the present invention illustrating the positional relationship between the tab portion and the label portion of the adhesive layer;

FIG. 3 is a top surface view of a label showing an example of the printed surface that can be used with the label of the present invention;

FIG. 4 is a back side view of a label of the present invention having a rectangular body and an edge portion without an adhesive layer;

FIG. 5 is a top view of the preferred embodiment of the present invention showing a plurality of labels maintained on liner paper;

FIG. 6 is a top surface view of an embodiment of the present inventions with printing relating to a food safety labeling system; and

FIG. 7 is a top surface view of another embodiment of the present invention with printing relating to a food safety labeling system.

### DETAILED DESCRIPTION OF THE PREFERRED EMBODIMENTS

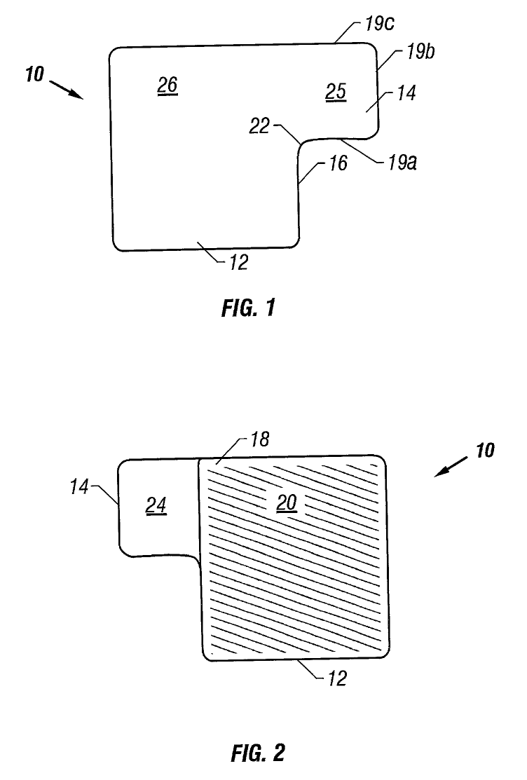

The present invention will now be better understood below by reference to the attached figures. Referring to FIGS. 1 and 2, there is shown an illustrative embodiment of an adhesive label that is adapted to withstand extreme fluctuations in environmental conditions, yet provide a label that is readily and easily removed from a receiving surface without leaving an adhesive residue or other label remnant.

As shown in FIG. 1, a preferred embodiment of the presently disclosed label includes an adhesive label (10) comprising a first section (12) contiguous with a second section (14). The second section forms a tab portion extending from the first section (12). The first section (12) has a first or back side (20) and a second or front side (26). The second section (14) has a first or back side (24) and a second or front side (25). Referring to FIG. 2, an adhesive layer (18) is provided on the first or back side (20) of the first section (12) for adhering the label to a receiving surface. The second or front sides (26) of the first section (12) and the second or front side (25) of the second section (14) have surfaces that allowing printing or writing thereon.

Referring to FIG. 2, there is shown a back view of the adhesive label (10). As shown, the adhesive layer (18) is provided across the first or back side (20) of only the first section (12) of the label (10), and the first or back side (24) of the second section (14) does not include an adhesive layer (18). In this way, the user of the label (10) places the label (10), or more specifically the first section (12), in contact with the substrate so as to adhere the adhesive layer (18) to the substrate surface. The tab portion (14), which does not include an adhesive layer, the first or back side (24) remains free from attachment to the substrate surface. To remove the label (10), the user simply grasps the tab portion (14) and pulls upwardly on the tab, thereby lifting the label (10) off of the substrate.

It is a preferred that the label (10) of the present invention be removable from a substrate, such as a food container, without leaving behind a label (10) remnant or residue from the adhesive layer (18). It is therefore preferable that the adhesive layer (18) be made from an easily removable adhesive, such as that commonly known in the art as a rubber based hot melt adhesive. In this regard, an adhesive suitable for use with the present invention is an adhesive sold by AVERY DENNISON under the trade name FASSON® R10. This adhesive is further preferred because it has an application temperature range of −10° C. to 50° C. and a wide service temperature range of −40° C. to 50° C. Additionally, the preferred adhesive provides a label (10) that will remain adhered to the substrate under wash conditions, yet is easily removed from the substrate by simply lifting upwardly on the tab portion (14).

Referring to FIG. 1, the tab portion (14) is shown having edges (19a-c) in which lower and upper side edges (19a) and (19c) respectively are parallel to each other and edge (19b) is the outer edge of tab (14). As illustrated, it is a preferred embodiment that the lower edge (19a) converge with the edge (16) of the first section (12) from which the tab portion (14) extends. The first section 12 can be in several different shapes such as a square, rectangle, circular or oval. As shown, it is preferred that the converging edges (16 and 19a) form a rounded edge (22) that is more resistant to tearing than is a sharp edge (ie., where the edges 16 and 19a form a right angle to each other). More particularly, the rounded edge (22) is less likely to tear when the tab portion (14) is pulled upwardly for the purpose of lifting the label (10) off of the substrate. This preferred embodiment is crucial in preventing the label (10) from tearing, and, thus, maintaining label (10) integrity to ensure that the label is completely removed from the substrate surface. Further, maintaining label (10) integrity is important where the label user desires to reposition the label.

Where the label (10) is made of a plastic sheet or other like sheet material, the preferred embodiment of a rounded or curved edge (22) functions to keep the label from splitting or tearing when removing the label. As such, the rounded edge (22) is designed to be used with a label that is preferably fabricated from a Polypropylene sheet material or other sheet material having like qualities. Fabricating the adhesive label (10) from Polypropylene provides an adhesive label (10) having high strength and durability as well as the desired resistance to moisture. A preferred Polypropylene base sheet material is FASSON® 3.8M Matte White Polypropylene/R-10 having Specification No. 75359, which is sold by AVERY DENNISON (250 Chester Street, Painesville, Ohio 44077). This preferred sheet material is a high opacity polypropylene film suitable for its strength and durability.

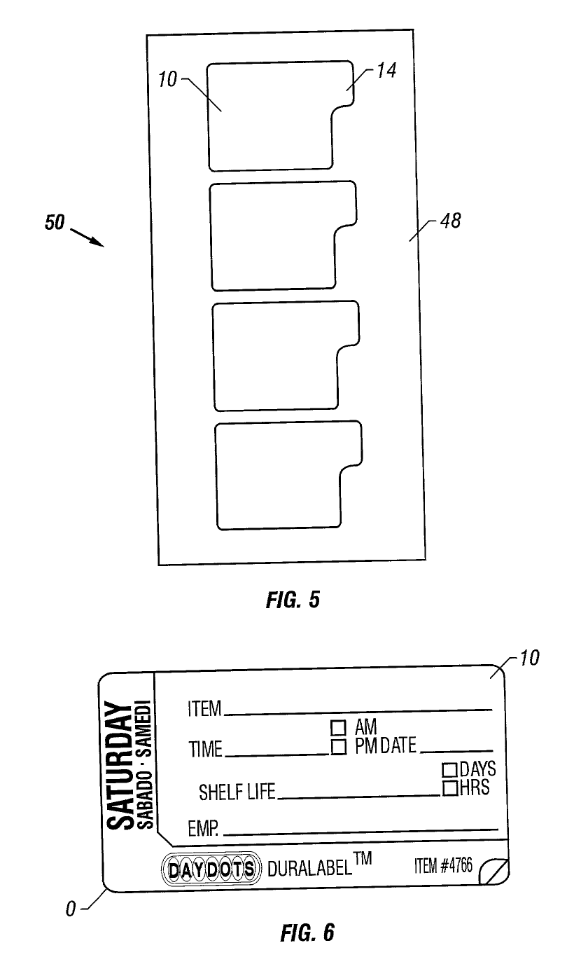

As illustrated in FIG. 5, an embodiment of the present invention includes providing a plurality of the adhesive labels (10) on a sheet of liner paper (48). In this way, the labels (10) can be provided on a sheet (50) of labels or on a roll of liner paper (not shown), as is known to one skilled in the art. In this embodiment, the tab portion (14) of the label (10) provides the label user with a convenient and easy means for removing the label (10) from a substrate surface and additionally from the liner paper (48). Specifically, the user obtains the label (10) by simply grasping the tab portion (14) and lifting the label off of the liner paper (48) used to construct the roll or sheet of labels (10). Holding the adhesive free tab portion (14), the label user can then easily apply the label to a substrate surface. A preferred liner paper for constructing the roll or sheet of labels is also sold by AVERY DENNISON under the trade name FASSON® 320 LF. The liner paper (48) has a surface that readily separates from the adhesive layer (18) of the label.

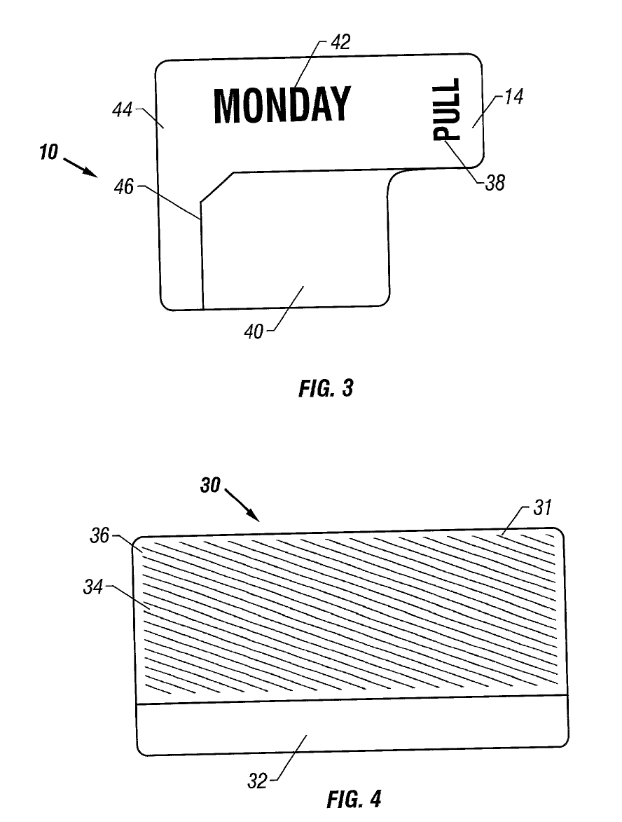

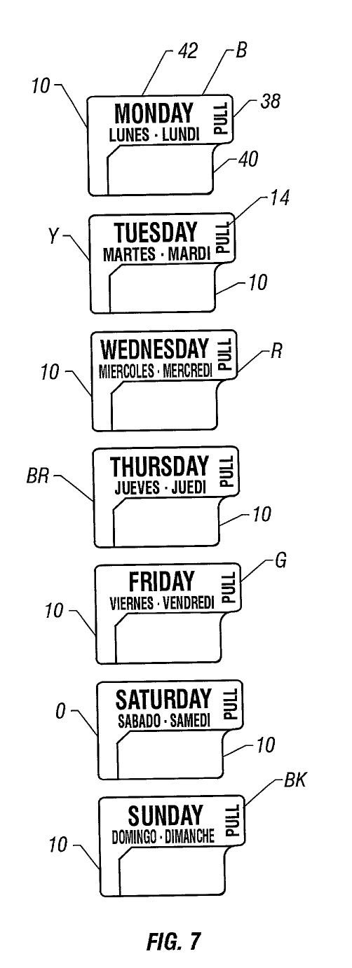

FIGS. 3, 6 and 7, illustrate preferred embodiments of the present invention showing printed information to assist the user of the label (10). As illustrated in FIGS. 3 and 7, the tab portion (14) includes the word “PULL” (38) printed on the front side (25). This instructs the user of the label (10) to pull on the tab portion (14) when it is desired that the label be removed from the surface. Another example of the type of information that can be provided is the day of the week, which for purposes of illustration is “MONDAY” (42) printed on the front side (26) of section (12). It is also preferable that the label (10) be color-coded. Particularly, the surface indicated as numeral (44) can be of any color in the known industry color code system used in food safety labeling systems. The colored surface (44), however, does not necessarily cover the entire upper surface of the label (10), but rather can terminate at a-boundary (46) adjacent a non-colored surface (40). In this embodiment, the non-colored surface (40) is preferably white, and provides a smooth surface, which is adapted to be easily written upon by a pen or pencil. It should be understood by those skilled in the art that various information boxes or blanks surfaces can be provided without deviating from the scope of the present invention.

The inventive labels 10 can be made to conform to the three main types of labels used in food safety labeling systems—day of the week FIFO (first in first out) systems, shelf-life/product identification labels and use by/use first labeling. The labels 10 can include the established food safety color code system in which the color blue B is for Monday, yellow Y for Tuesday, red R for Wednesday, brown BR for Thursday, green G for Friday, orange 0 for Saturday, and black BK for Sunday (FIGS. 6 and 7). The labels 10 can also include day-of-the-week text, as illustrated in FIGS. 3, 6 and 7 as well as other food rotation text. Preferably, the text will be multilingual to include any combinations of English, Spanish, French, Italian or German. Additionally, the inventive labels 10 will utilize face materials and adhesives specifically designed for food rotation and FIFO labeling in the food services industry.

FIGS. 4 and 6 illustrate an alternate embodiment of the present invention made in accordance of the label illustrated in FIGS. 1 and 2. FIG. 4 shows the first or back side (34) of a label (30) that comprises a substantially rectangular section including an edge portion (32) that is free of any adhesive. The remaining portion of the back side (34) of the label (30) includes an adhesive layer (36). As described above, the purpose of the adhesive free edge portion (32) is to provide a user of the label (30) with the means for grasping the label (30) and removing it from the substrate by pulling upwardly on edge portion (32). FIG. 6 illustrates the printing that can be placed on the second or front side of the label (30).

Various embodiments of the present invention have been described herein. It should be understood by those of ordinary skill in the art, however, that the above described embodiments of the present invention are set forth merely by way of example and should not be interpreted as limiting the scope of the present invention, which is defined by the appended claims. Many other alternative embodiments, variations and modifications of the foregoing embodiments that embrace various aspects of the present invention will also be understood upon a reading of the detailed description in light of the prior art. For instance, it will be understood that features of one embodiment may be combined with features of other embodiments while many other features may be omitted (or replaced) as being nonessential to the practice of the present invention.

What is claimed is:

1. An adhesive label, comprising:
a label having a first and second section, each section having first and second opposite sides, wherein the first side of the first section is contiguous with the first side of the second section;
an adhesive layer adapted to releasably adhere the label to a substrate surface, the adhesive layer confined to covering at least a portion of the first side of the first section;
the second section forming a tab portion extending from the edge of the first section; and
wherein, the first side of the second section does not include an adhesive layer, whereby the label is adapted to be removed from a substrate surface by lifting the tab portion away from the substrate surface.

2. The adhesive label claimed in claim 1, wherein the first section is in a shape selected from a group consisting of a square shape, rectangular shape, circular shape and oval shape, the first section have a plurality of edges and the second section is a rectangular tab portion, the rectangular tab portion extending from one of the edges of the first section.

3. The adhesive label claimed in claim 2, wherein the edge of the first section from which an edge of the second section extends converges with the edge of the second section to form a rounded edge between the first and second sections.

4. The adhesive label claimed in claim 1, wherein the label is fabricated from a material comprising polypropylene.

5. The adhesive label claimed in claim 3, wherein the first and second sections are fabricated from a material comprising polypropylene.

6. The adhesive label claimed in claim 1, wherein the second side of the label has a surface adapted to accept printing of text.

7. The adhesive label claimed in claim 6, wherein the text printed on the second side of the label is related to text used in food safety labeling systems.

8. The adhesive label claimed in claim 7, wherein the text used in food safety labeling systems is selected from a group consisting of text found in day of the week FIFO food safety labeling systems, text relating to shelf-life/product identification food safety labeling systems and text relating to use by/use first food safety labeling systems.

9. The adhesive label claimed in claim 1, wherein the second side of the label has a surface adapted to accept printing of color.

10. The adhesive label claimed in claim 9, wherein the color printed on the second side of the label is related to an industry standard color code system used in food safety labeling systems.

11. The adhesive label claimed in claim 10, wherein the industry standard color code system is selected from a group of colors consisting of blue for Monday, yellow for Tuesday, red for Wednesday, brown for Thursday, green for Friday, orange for Saturday, and black for Sunday.

12. The adhesive label claimed in claim 1, wherein the adhesive is adapted to remain adhered to a substrate from a temperature range of about −40° C. to 50° C.

13. The adhesive label claimed in claim 1, wherein the adhesive is adapted to be adhered to a substrate from a temperature range of about −10° C. to 50° C.

14. An adhesive label, comprising:
a first portion having opposing first and second sides;
an adhesive layer on the first side of the first portion, the adhesive adapted to releasably adhere the label to a substrate;
a second portion extending from an edge of the first portion, the second portion having a nonadhesive first side juxtaposed to the adhesive layer on the first side of the first portion;
the second side of the first portion has a surface adapted to be written upon with a pencil and/or pen; and
wherein, the label is adapted to be removed from a substrate by pulling the nonadhesive second portion away from the substrate, whereby the label is lifted from the substrate.

15. The adhesive label claimed in claim 14, wherein the second portion is a rectangular tab extending from the first portion.

16. The adhesive label claimed in claim 15, wherein the rectangular tab includes a first edge extending from an edge of the first portion, the tab edge and first portion edge converging to form a rounded edge.

17. An adhesive label, comprising:
a label having first and second sections, each section having contiguous first and second opposite sides;
an adhesive layer adapted to releasably adhere the label to a substrate, the adhesive layer overlaying the first side of the first section only;
the second section forming a tab portion extending horizontal to the first section, the tab portion having an edge interconnected with an edge of the first section, the interconnected edges forming a rounded edge, and the first side of the second section being nonadhesive;
wherein, the label is adapted to be removed from a substrate by lifting the nonadhesive second section away from the substrate so as to lift the label from the substrate.

18. The adhesive label claimed in claim 17, wherein the label is fabricated from a material comprising polypropylene.

19. The adhesive label claimed in claim 17, further including a label liner, the label liner having a first surface adapted to releasably engage the adhesive layer on the label, wherein the label is removable from the liner to expose the adhesive layer.

20. The adhesive label claimed in claim 19, wherein the label is a plurality of labels on the first surface of the label liner.

21. The adhesive label claimed in claim 20, wherein the label liner is a single sheet holding the plurality of labels thereon.

22. The adhesive label claimed in claim 20, wherein the label liner is a strip of label liner adapted to form a roll, the rolled strip of label liner holding a plurality of labels thereon.

23. The adhesive label claimed in claim 17, wherein the second side of the label has a surface adapted to accept printing of text.

24. The adhesive label claimed in claim 23, wherein the text printed on the second side of the label is related to text used in food safety labeling systems.

25. The adhesive label claimed in claim 24, wherein the text used in food safety labeling systems is selected from a group consisting of text found in day of the week FIFO food safety labeling systems, text relating to shelf-life/product identification food safety labeling systems and text relating to use by/use first food safety labeling systems.

26. The adhesive label claimed in claim 17, wherein the second side of the label has a surface adapted to accept printing of color.

27. The adhesive label claimed in claim 26, wherein the color printed on the second side of the label is related to an industry standard color code system used in food safety labeling systems.

28. The adhesive label claimed in claim 27, wherein the industry standard color code system is selected from a group of colors consisting of blue for Monday, yellow for Tuesday, red for Wednesday, brown for Thursday, green for Friday, orange for Saturday, and black for Sunday.

29. An adhesive label, comprising:
a first portion having opposing first and second sides;
an adhesive layer on the first side of the first portion, the adhesive adapted to releasably adhere the label to a substrate;
a second portion extending from an edge of the first portion, the second portion having a nonadhesive first side juxtaposed to the adhesive layer on the first side of the first portion;
the second side of the first portion has a surface adapted to be written upon with a pencil and/or pen;
the second side of the first portion has a surface adapted to accept printing relating to food safety labeling systems; and
wherein, the label is adapted to be removed from a substrate by pulling the nonadhesive second portion away from the substrate, whereby the label is lifted from the substrate.

30. The adhesive label claimed in claim 29, wherein the printing on the second side of the label includes text relating to food safety labeling systems.

31. The adhesive label claimed in claim 30, wherein the text relating to food safety labeling systems is selected from a group consisting of text found in day of the week FIFO food safety labeling systems, text relating to shelf-life/product identification food safety labeling systems and text relating to use by/use first food safety labeling systems.

32. The adhesive label claimed in claim 29, wherein the printing on the second side of the label includes color relating to color code systems used in food safety labeling systems.

33. The adhesive label claimed in claim 32, wherein the industry standard color code system is selected from a group of colors consisting of blue for Monday, yellow for Tuesday, red for Wednesday, brown for Thursday, green for Friday, orange for Saturday, and black for Sunday.
